(19) United States
(12) Patent Application Publication
(10) Pub. No.: US 2025/0089942 A1
(43) Pub. Date: Mar. 20, 2025

(54) MODULAR FRAME FOR AN OUTDOOR KITCHEN

(71) Applicant: BURNHARD GmbH, Düsseldorf (DE)

(72) Inventor: Max RUHFUS, Düsseldorf (DE)

(73) Assignee: BURNHARD GmbH, Düsseldorf (DE)

(21) Appl. No.: 18/883,326

(22) Filed: Sep. 12, 2024

(30) Foreign Application Priority Data
Sep. 18, 2023 (EP) 23 197 899.0

(51) Int. Cl. A47J 37/06; A47J 37/07

(52) U.S. Cl. CPC A47J 37/0682; A47J 37/0786

(57) ABSTRACT

A modular frame for an outdoor kitchen for the replaceable accommodation of at least one function module includes a frame body having a first side part and a second side part opposite the first side part, a front part and a rear part opposite the front part for defining a frame interior; a first accommodating device; and at least one media distribution device. The at least one media distribution device has at least two connectors and a line device. The line device can distribute at least one medium between the at least two connectors. A first connector is arranged in an area of the first side part and a second connector is configured for connection to the at least one function module. The at least one function module can be connected to the frame body and/or supported at the frame body via the first accommodating device.

### CROSS-REFERENCE TO RELATED APPLICATIONS

This application claims priority under 35 U.S.C. § 119 to European patent application EP 23197899.0, filed Sep. 18, 2023, the disclosure of which is incorporated herein by reference in its entirety.

### BACKGROUND

### 1. Field of the Disclosure

The present disclosure relates to a modular frame for an outdoor kitchen for the interchangeable accommodation of at least one function module.

### 2. Description of Related Art

A plurality of frame modules for an outdoor kitchen, which include at least one function module, is known from prior art. The outdoor kitchens can, in particular, comprise a grill.

It is already known to design the grill area of an outdoor kitchen in a multi-functional manner. For example, a grill can have several grill areas and be divided into several functional sub-areas. The grill area can then, for example, include a grill grate, a frying area and a plancha area, which means that the grill of the prior art can fulfill several functions.

To extend the range of functions of the aforementioned grill or an outdoor kitchen in general, the aforementioned frame modules comprising at least one function module are usually arranged to the side of the grill area and/or main cooking area of an outdoor kitchen in order to add further functions to the outdoor kitchen.

Different function modules, such as gas stoves, ceramic burners, hotplates, etc., are usually arranged in the frame module, as known from prior art. According to the known prior art, the frame module and the function module are permanently connected to each other, such as bolted or even materially bonded, so that a separation of the function module and frame module is only possible with considerable effort or not at all.

The known frame modules also have the problem that they have a frame specifically adapted to the respective function module or design features that do not easily allow the function module to be replaced. In particular, the feed and discharge lines are specifically adapted to the respective function module. The user who wants to use a grill or an outdoor kitchen with different function modules therefore needs a corresponding amount of space to arrange or store all the desired frame modules, each comprising a specific function module, in the outdoor kitchen. In addition, the production of such frame modules specifically adapted to the respective function module is material and cost-intensive.

### SUMMARY

Based on the described disadvantages of the frames or frame modules of outdoor kitchens or grills known from prior art, it is therefore the object of the present disclosure to provide a modular frame for an outdoor kitchen for an interchangeable accommodation of at least one function module.

According to a first aspect, the present disclosure relates to a modular frame for interchangeably accommodating at least one function module.

The present modular frame for an outdoor kitchen for the replaceable accommodation of at least one function module comprises: a frame body with a first side part and a second side part opposite the first side part, a front part and a rear part opposite the front part for delimiting a frame interior, a first accommodating device and at least one media distribution device; wherein the at least one media distribution device comprises at least two connectors and a line device; wherein the line device is configured to distribute at least one medium between the at least two connectors; wherein a first connector of the two connectors is arranged in a region of the first side part and a second connector of the two connectors is configured to be connected to the at least one function module; and wherein the at least one function module can be connected to the frame body and/or can be mounted on the frame body via the first accommodating device.

Different function modules can be accommodated, stored and, if necessary, replaced in the interior of the modular frame according to the disclosure. The user of the modular frame can thus select a desired function module as required and use it in the uniform modular frame, so that the outdoor kitchen or grill comprising the modular frame according to the present disclosure can be designed in an advantageous space-saving manner.

At the same time, the modular frame offers the user a high degree of flexibility, as, depending on the intended use, the desired specific function module can be used, so that the user only has to purchase the desired function module for an alternative use and not a complete grill, a complete outdoor kitchen or a separate frame module specifically adapted to a function module.

In this way, the modular frame also counteracts the cost- and resource-intensive production of outdoor kitchens and grills, as the user only needs one modular frame to accommodate an interchangeable function module and can therefore use a large number of differently designed function modules with the modular frame. This is an advantageous way to avoid having to buy several grills in different sizes or expensive additional modules.

In addition, maintenance of the grill using the frame according to the present disclosure is facilitated, since in the event of a defective function module of a grill, only the defective function module needs to be serviced, rather than the entire grill.

A further advantage of the modular frame according to the disclosure is that the respective function module can be connected to the frame without tools and can also be disconnected again, whereby a media supply is realized by the media distribution device provided and in particular via the second connector.

In the context of the present disclosure, the function module can be understood, for example, as a ceramic burner module, a cooking module, such as in particular a gas-operated or electric cooking field, a pizza oven, a wok burner, a plancha grill or an adapter for receiving a stainless steel container. Here, the ceramic burner module comprises at least one ceramic burner arranged below a grill grate. The burner can also be designed as an infrared burner.

The cooking module comprises a cooking area that can be heated via a burner or a heating module. As an alternative, the cooking module can also comprise a plurality of cooking areas heated via one or via a plurality of burners. As a further alternative, an induction cooking field can be provided for the cooking module. The energy supply of the corresponding cooking and/or function module is effected via the media distribution device and via the second connector of the media distribution device, respectively.

The function module designed as a pizza oven has a closeable oven space which can be heated via at least one burner.

The wok burner is geometric arrangement of at least one burner that is particularly advantageous for using, storing and heating a wok. Here, the wok burner can have a concave recess for storing the wok and thermal transfer to the wok.

The plancha grill further provides a grilling plane with a rim extending around the side.

The stainless steel container can be designed, for example, as a container for storing grill food or for holding fresh water.

Thus, the present disclosure provides different function modules for different functions, which can be replaced and subsequently used in an advantageous way via the modular frame.

The frame body of the modular frame defines a frame interior through the first and second side parts as well as through the front parts and rear parts. The interior of the frame is designed to arrange and accommodate the function modules. The function module can be arranged in the frame interior in an upper, middle or lower area. The frame body is preferably made of a metal material.

The design of the frame body according to the present disclosure can have a rectangular geometry. Preferably, the first and second side parts can be arranged parallel to each other. The front part and the rear part can also be designed parallel to each other.

A mount for a rotisserie can also be arranged or formed on the frame body, in which the mount can, for example, be designed so that the rotisserie mount is supported so that it is displaceable relative to the frame body.

Furthermore, the frame body can be made of a plate-shaped material and preferably have material thicknesses between 0.5 mm and 3.0 mm, more preferably between 1.0 and 2.0 mm. Such material thicknesses of the frame body have proven to be particularly stable and advantageously suitable for the present disclosure.

Optionally, it is provided that the first side part, the second side part, the front part and/or the rear part of the frame body are made of a metal alloy. The respective side parts can also be made of different alloys. Such an alloy can be a stainless steel, for example. By such a design of the respective side parts, the modular frame is particularly stable and advantageously resistant to high temperatures and weather-related influences.

The frame body can also be designed as a circumferential frame part. In such a design, the frame body can have a elliptic or circular geometry, in which the transitions from, for example, the first side part to the front part are smooth. However, the frame body can have an arcuate shape only in the area of specific parts. The above designs have the advantage that the correspondingly designed modular frames can also be adapted to round parts of an outdoor kitchen, such as a kettle grill or a kamada grill, and be fastened thereto.

The at least one function module can be connected to the frame body and/or supported at the frame body via the first accommodating device of the modular frame. The first accommodating device can be designed as a protrusion of the frame body or as an additional structure. For example, the accommodating device can be designed as a metal sheet extending circumferentially in the frame, having an edge directed towards the frame interior. It can also be provided to design the accommodating device by folding at least parts of edge portions of components of the frame body. The folded edge portions can then serve as a support surface for the function module.

Further, the modular frame comprises at least one media distribution device which comprises at least two connectors and a line device.

The connector can comprise in particular two connector parts adapted to one another, which can be connected, and particularly preferably locked with each other, to establish a media-tight connection. According to the disclosure, connecting and disconnecting the two connector parts can be done without a tool, for example, in the form of a spring-loaded quick-action coupling.

In the context of this disclosure, a connector can be a plug, an adapter, a connection device, a coupling, a port or a valve, for example. A hose connector or a plug connector is also understood as a connector in the context of the disclosure. Line devices can be connected to one another via a connector.

The line device can be designed, for example, as a hose for a medium such as a fluid, in particular a gas or water, and for the distribution of the at least one medium between the at least two connectors. Further, the line device can also be designed as a wire through which electric current or electric signals are fed as a medium. The line can be designed so that it conducts a plurality of media, e.g. a gas through a hose and, in parallel, an electric current through a wire that is arranged outside the hose, for example. For example, the conduit device can comprise a media-carrying main lumen and optionally at least one secondary lumen, whereby electrically conductive lines are installed, for example.

The current can be provided in a low-voltage or medium-voltage range, in which the current can be conducted to an electrically operated function module.

The connector can also be used to connect several line devices together without any loss of medium in the area of the connector. In other words: the connector is designed to be media-tight, as is the line device.

Of course, the connector, similar to the line device, can be designed so that it connects line devices that contain a medium, for example, and also connects line devices that conduct electrical current or electrical signals.

In the context of this disclosure, water or gray water, electrical signals and other fluids are understood as a medium, besides electrical current or gas.

The modular frame has a first connector in an area of the first side part and a second connector for connection to the at least one function module. This allows the medium to be routed from the first side part to the function module through the line device. Alternatively, the first connector can also be arranged on the second side part, on the front part or on the rear part.

The modular frame according to the disclosure advantageously enables the medium to be routed from the frame body to the function module. The first accommodating device, via which the at least one function module can be connected to the frame body and/or can be supported on the frame body, is preferably formed in an upper edge region of the frame body in order to store the function module in the upper frame region or to be connected to the frame. The modular frame provides the benefit of making it particularly easy to replace a function module with another function module, in addition to arranging the same. Since the function module can be integrated with the frame body and thus into the modular frame via the first mounting device, the simple and modular design of the modular frame makes it particularly easy to change the function module, which change can preferably be carried out without tools and without major effort for the user.

Preferably, the line device of the media distribution device is arranged on the front part of the frame body. For example, the line device can extend parallel to the front part and parallel to a center plane of the function module, in which the center plane of the function module is arranged parallel to the floor. In such an arrangement of the line device, the first connector can be arranged on the first or second side part of the frame body. The line device can, for example, be connected or attached to the frame body via mounting devices such as a clip device. The arrangement of the line device at the front part of the frame body makes the media distribution device accessible to the user in a particularly advantageous manner.

Optionally, the frame body has a geometry adapted to the function module. For example, a function module designed as a stainless steel container can have a geometry adapted so that the stainless steel container can be suspended inside the frame body. The function module thus fills the inside of the frame body in a particularly aesthetic and easy-to-clean manner, making efficient use of the space provided by the frame body.

In a preferred embodiment, the connectors are each designed to be connected to an adapted connector or a connection device. The connector can, for example, be designed as a male connector with an insertion part so that it can be connected to the adapted connector, i.e. a connector designed as a female connector. Of course, the connector can also be designed as a female connector and the adapted connector as a male connector. Alternatively, the connector can also be designed as a sleeve. The connector and the adapted connector are connectors adapted to each other, the adapted connector being arranged opposite the connector. The connector and the adapted connector are connected to each other in a media-tight manner and can preferably be connected and disconnected without tools. Alternatively, the connector can also be connected to a connection device, where, for example, the connection device can be a gas cylinder valve or a gas or water connection of a house.

With such a design of the connectors, they can be connected to adapted connectors or a connection device in a particularly simple manner, so that the connectors and thus the media distribution device can be integrated particularly easily into an existing media system or so that the media distribution device can be extended in a particularly easy manner.

In particular, the connector can be designed as a quick coupling, in which a first quick-connection part is connected to the line device in a media-tight manner and a second quick-connection part adapted to the first quick-connection part can be formed on the function module, for example, to connect the second quick-connection part to the first quick-connection part. For example, the connector can be designed as a plug-in coupling comprising a plug-in part and an opposing sleeve part.

The connector can preferably comprise a spring-loaded locking device that engages when the connection of the two connector parts is established to lock them. The locking device can be moved against the spring force, allowing the two connector parts to be released again and the connection to be separated again.

Preferably, the media distribution device includes a media control device for controlling the at least one media flow in the line device between the first connector and the second connector. The media control device can either be integrated directly into the line device or, for example, by a throttle valve. The flow of the medium is regulated by the medium control device, and the flow of a medium stream can be regulated down to 0 and switching on and off by the medium distribution device is also made possible via the medium control device. Furthermore, the media control device can also be designed as an adjustable pressure reducer, for example. The media flow or the medium is controlled in a particularly advantageous manner by the media control device, so that the user can influence the flow behavior of the medium in a particularly advantageous manner.

In a preferred embodiment, the frame body comprises a second accommodating device via which at least one cabinet module can be connected to the frame body. The second accommodating device can preferably be arranged in a lower edge area of the frame body and can, for example, be designed as a projection, an insert or another structural feature. For example, the cabinet module can be arranged underneath the frame body using the second accommodating device, and the cabinet module can have castors, doors, drawers, walls, and the like. Further, the cabinet module can be used for storing a media source or a media storage unit, for example, a gas cylinder or an accumulator, which are, as is particularly preferred, designed for connection to the media distribution device. Due to the second accommodating device, the modular frame can thus be supplemented in a simple manner by at least one cabinet module.

Preferably, the frame body has a stop on the first side part, the second side part, the front part and/or the rear part to form the first and/or second accommodating device, via which the corresponding function module and/or cabinet module can be locked to the frame body. The stop can be formed either immediately on the frame body or be formed by an additional component on the frame body. The stop can also be formed by partly folding or beveling a plate-shaped portion of the respective part of the frame body. The stop can be provided or formed on the entire frame body or only on parts of the frame body, for example on opposite sides of the frame body. The function module and/or the cabinet module is advantageously arranged and locked in a particularly stable manner on the frame body by the stop, so that the function module and/or the cabinet module can be connected to the frame body as firmly and with as little play as possible. Furthermore, the design of the at least one stop increases the rigidity, in particular the flexural rigidity, of the frame body.

In a preferred embodiment, the media distribution device is L-shaped, and the first connector can be connected to the function module via the line device and via the second connector. In such an embodiment, the second connector can be arranged above the first connector, and the function module can also be connected above the second connector. The line device arranged between the first and second connector can be designed to be linear so that the medium can flow through the line device with as little resistance as possible. The L-shaped design of the media distribution device allows a medium to flow through the line device in a particularly advantageous way. Furthermore, the L-shaped media distribution unit provides an aesthetically pleasing appearance.

Preferably, the media distribution device has at least one third connector in an area of the second side part. The medium first flows from the first connector, which is arranged on the first side part, via the line device and the second connector to the function module, with another part of the medium continuing to flow through the line device to the third connector. The line device can also comprise a distributor via which the medium is routed from the first connector to the second and third connectors.

The third connector expands the media flow of the media distribution device so that a portion of the media flow can be used beyond the function module. Due to the arrangement of the third connector on the second side part, the medium flows from the first side part towards the second side part via the function module. The third connector expands the media distribution device in an advantageous manner, so that the user is given at least one additional connection option. The third connector can, for example, be used to connect a first connector of another function module.

In a preferred embodiment, the media distribution device has a fourth connector for connecting at least one media source. The fourth connector provides a further connection option on the media distribution device so that a media source can be connected to the media distribution device. However, it is also possible for the media source to be connected to the first, second or third connector. The fourth connector for connecting the at least one media source advantageously provides the possibility of connecting a media source to the modular frame. The modular frame and thus the function module can be advantageously supplied with at least one medium via the media distribution device.

Preferably, at least one connector is arranged on the frame body via a quick-action device. The quick-action device connects the connector to the frame body on the one hand and aligns the connector in a preferred direction on the other hand, for example in the direction of the function module to be connected. For example, the connector can be aligned by the quick-action devices so that a vertically flowing medium flows upwards through the connector towards the function module. By aligning the connector, the medium can therefore flow advantageously and directly, i.e. without detours through kinks, loops or bends, in the line device towards the function module. Furthermore, the at least one connector is particularly easy for a user to access due to the quick-action device and at the same time enables the connection to other function elements, for example, in a particularly simple manner.

If the second connector is arranged on the frame body via the quick-action device, the quick-action device also makes it particularly easy to change the function module, as the user does not need to use tools or perform complex modifications to disconnect a function module connected via the connector from the media distribution device and reconnect an alternative function module to the media distribution device via the connector. The quick-action device thus allows to change, install and remove function modules in a particularly easy manner and without effort. Due to the quick-action device, the function module is designed to be fixed to the frame body or separated from the same, respectively.

In a preferred embodiment, it is provided that the media distribution device is T-shaped, in which the first connector can be connected to the function module in a media-conducting manner via the line device through the second connector, and the third connector can be connected to a further media distribution device and/or a further function module via the line device, and the first connector is connected to the third connector and the third connector is connected to the second connector in a media-conducting manner via the line device. The T-shaped design of the media distribution device enables the medium to flow from the first connector via the line device through the second connector to the function module and from the function module or from the second connector to the third connector via the line device, and preferably from the first connector to the third connector. The medium then flows to the additional media distribution device and/or the additional function module via the line device and the third connector. The media distribution device of T-shaped design thus allows for a serial or parallel juxtaposition of function modules and/or further media distribution modules. Due to the T-shaped design, the medium can further advantageously flow almost horizontally from the first side part to the second side part. However, an additional media source can be connected to the media distribution device via the third connector.

The media distribution device of T-shaped design provides a type of modular principle for the modular frame, whereby the T-shaped media distribution device can be expanded in a modular manner with further modular frames or further function modules or further media distribution devices. The modular frame can thus be optionally expanded in a particularly advantageous manner via the T-shaped media distribution device. The design of the media distribution device ensures that each frame and each function module accommodated in a frame can be supplied with at least one medium.

Preferably, it is provided that the first accommodating device is designed for arranging the at least one function module at least partly in the area of the frame interior between the front part and the rear part, as well as between the first and the second side part. The first accommodating device can, for example, be directed inwards towards the frame interior. By such a first accommodating device design, the installed at least one function module can cover the first accommodating device for a user looking upon the same, so that only the function module is visible to the user of the modular frame. Such a design of the modular frame with the first accommodating device offers an aesthetically particularly pleasant appearance to the user.

Preferably, it is provided that a horizontal center axis extends through the frame interior and parallel to the first and second side parts, as well as to the front part and the rear part, the frame being mirror-symmetrical starting from the center axis. The horizontal center axis divides the frame interior into two areas of the same size. Due to the mirror-symmetrical design of the frame relative to the horizontal center axis the same parts can be used at different positions when constructing the frame. Moreover, the mirror-symmetry of the frame can, for example, also be applied to a lower cabinet arranged on the frame. In this case, for the lower cabinet, side parts of the same geometry can be used at a plurality of positions. The mirror-symmetrical design of the frame thus advantageously reduces the complexity of the modular frame and of a lower cabinet arranged on the modular frame.

The media distributing device preferably comprises at least one connection device for transmitting data and/or electric energy. The connection device can be configured as a USB interface, for example, and be arranged on the frame body of the modular frame via the media distribution device. For example, a USB interface can be provided on the front part of the frame body. The connection device on the media distribution device advantageously makes it possible to supply external devices, such as a smartphone, with electrical energy or to enable data transfers between different devices.

In a preferred embodiment, it is provided that the frame body is designed to accommodate an electrical energy source for connection to the media distribution device for the supply of electrical energy to at least one function module accommodated in the frame. The energy source can be designed as a mobile energy source, in particular in the form of a power bank or an accumulator with a voltage converter, and more particular an inverter. For example, the accumulator can supply a function module designed as a rotating spit with power and drive the rotating spit. At the same time, the accumulator could power external devices such as a smartphone or a valve gate. By accommodating the electrical energy source, a function module can be operated autonomously in an advantageous manner, and, in addition or as an alternative, external devices can be supplied with electrical energy.

According to a further aspect, this disclosure relates to a system for an outdoor kitchen with at least one modular frame and with at least one function module and/or at least one cabinet module. The function module can preferably be connected or attached to the modular frame without tools and can likewise be detached from the same without tools. The cabinet module can also be configured to be connected to the modular frame without tools. The connection of the function module and/or cabinet module to the modular frame can be made using a plug-in connection, for example. Additional screw connections or locking devices can be provided to stabilize individual areas. The function module and/or the at least one cabinet module can be arranged on the modular frame in a particularly simple manner and be connected to the same in a load-bearing manner.

In a preferred embodiment, the function module is designed as a ceramic burner module, a cooking module, a pizza oven, a wok burner, a plancha grill and/or as an adapter for holding a stainless steel container. A rotary spit and optionally a back burner can also be arranged on the ceramic burner module. Depending on the user's requirements, the desired function module can be used in a particularly simple manner and be replaced by another function module if necessary. For example, in this type of system, the user first has the option of using the function module designed as a pizza oven and then replacing the pizza oven with the function module designed as a wok burner. The user only needs the space for one function module in the outdoor kitchen, but can choose between a variety of different function modules. If there is a need to use several function modules, the user can extend the modular frame as required to connect a function module and thus connect and combine almost any number of function modules. Of course, each function module can also have a cabinet module, for example. It is particularly preferable that the function modules not accommodated in the frame can be stored in the cabinet module. For this purpose, at least one accommodating device can be formed in the cabinet, on which the function module can be stored and/or fixed.

Due to the modular frame according to this disclosure, replacing the individual function modules is particularly easy for the user. Due to the structural features, the system advantageously requires little space and the user can further flexibly choose from a variety of function modules when assembling the desired function modules.

Preferably, it is provided that a lid is pivotally provided on the function module to partially or completely cover the function module. Here, the lid can be pivotally arranged in the area of the rear part. The lid can be filled with an insulating material such as rock wool in order to insulate the environment of the lid from an increased temperature that can develop under the lid.

The lid can also be designed to be linearly guided and pivotable, so that the lid is first pivoted upward, thus exposing the function module. Thereafter, the lid can be guided towards the ground behind the rear part via a linear guide. By providing a hinged lid, the function module can be covered in a particularly simple manner, for example to protect it from the weather or to provide an enclosed space below the cover and above the function module. Furthermore, the linear guide allows the lid to be positioned outside the user's field of vision and working area in a particularly aesthetic manner.

In a preferred embodiment, at least one further modular frame and/or one further function module is arranged on the modular frame, and the media distribution device of the modular frame can be connected to a media distribution device of the further modular frame. By designing the system in this manner, a modular frame can be expanded as required with a further modular frame and/or further function modules. For example, the modular frames allow the user to combine a pizza oven function module with a ceramic burner function module and a stainless steel container function module without having to carry out complex restructuring. The media distribution devices of the respective modular frames can be connected to each other so that the respective media can be routed as far as required and only one media source is used for all modular frames and all function modules. This makes it particularly easy to expand the system or replace function modules.

Preferably, at least one media source and/or one media sink is arranged on the media distribution device. For example, a gas source or a fresh water source can be used as the media source. A container that collects the used water, for example, can be used as a media sink in this context. Alternatively, a discharge line can also be connected to the at least one media distribution device as a media sink. The media discharged is thus also effected via the media distribution device.

By connecting at least one media source and/or at least one media sink to the media distribution device, the supply to and/or discharge from the function modules accommodated in the frame is thus ensured in an advantageous manner.

### BRIEF DESCRIPTION OF THE DRAWINGS

In the following, exemplary embodiments of the modular frame according to the disclosure and the system according to the disclosure are explained in more detail with reference to the Figures.

FIG. 1 is a schematic illustration of an exemplary embodiment of a modular frame for an outdoor kitchen according to the disclosure.

FIG. 2 is a schematic illustration of an exemplary embodiment of a media distribution device.

FIG. 3 is a schematic illustration of an exemplary embodiment of a system for an outdoor kitchen according to the disclosure with a modular frame.

### DETAILED DESCRIPTION OF THE DISCLOSURE

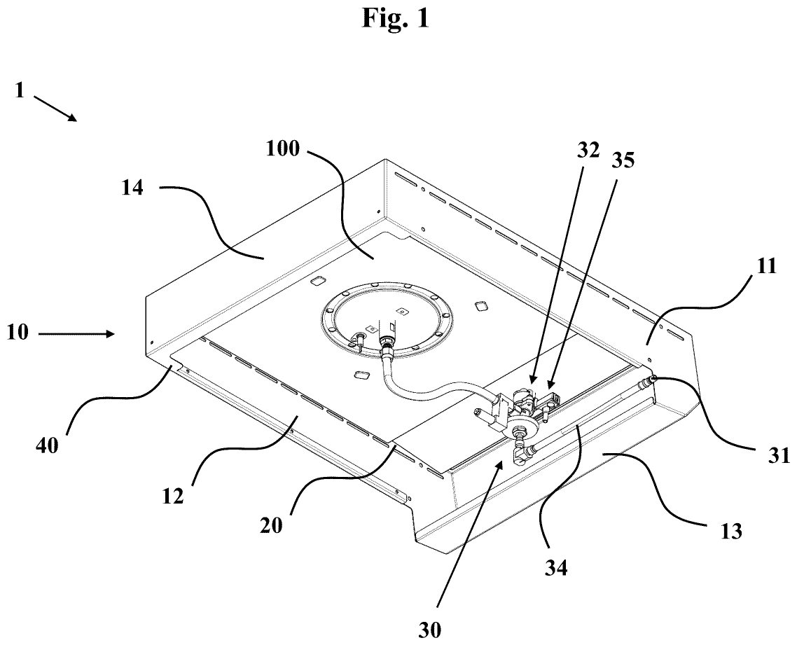

FIG. 1 is a schematic illustration of an exemplary embodiment of a modular frame 1 for an outdoor kitchen according to the disclosure, for the replaceable accommodation of at least one function module, illustrating a view on the modular frame 1 from below.

FIG. 1 shows a modular frame 1 with a frame body 10 having a first side part 11 and a second side part 12 opposite the first side part 11, a front part 13 and a rear part 14 opposite the front part 13 for defining a frame interior. At the front part 13 of the frame body 10, a media distribution device 30 is arranged via which a medium, e.g. a combustible gas, is routed to different areas of the modular frame 1.

In an upper area of the modular frame 1, a first accommodating device 20 is arranged via which a function module 100 designed as a cooking module is arranged and supported on the frame body. According to the disclosure, the function modules 100 are not limited to the cooking module illustrated, rather, different modules can be provided, such as, inter alia, a ceramic burner module, a sink module, a meat module etc. The first accommodating device 20 is designed as a protrusion in the upper area of the frame body 10, covered in FIG. 1, so that the function module can be arranged in the frame body 10 in a structurally simple and at the same time stable manner. Due to the simple and modular structure of the modular frame 1, a particularly simple mounting of the function module 100 is ensured, while it is possible at the same time for the user to change the function module 100, preferably without a tool and without effort.

The function module 100 can be supplied with a medium via a medium distribution device 30, which medium flows through the medium distribution device 30. The illustrated embodiment of the medium distribution device 30 is of L-shaped design and has a first connector 31 that is arranged at the first side part via a line device 34. The media distribution device 30 can be connected, for example, to a further media distribution device 30 of a further modular frame 1 or a media source via the laterally positioned first connector 31. The media distribution device 30 further comprises a second connector 32 which is connected to the function module 100. Thus, by the second connector 32, the function module 100 is connected to the first connector 31 via the line device 34. The function module 100 can comprise a medium control device 35 for controlling a media flow. The media control device 35 can be arranged between the first and the second connector 31, 32 and can be configured to control the media flow in the line device 30. In the embodiment illustrated, the media control device 35 is designed as a throttle valve, whereby the flow of the media flow can be regulated down to 0, and wherein it is also possible to switch the function module 100 designed as a cooking module on and off by the media distribution device 30 via the media control device 35. By connecting the function module 100 via the second connector 32, the former can be changed in a particularly simple manner.

In a lower edge portion of the frame body 10, a second accommodating device 40 is formed, via which at least one cabinet module can be connected to the frame body 10. In the exemplary illustrated embodiment, the second accommodating device 40 is designed as a protrusion arranged at the frame body 10. With the second accommodating device 40, the modular frame 1 can be supplemented in a simple manner by at least one cabinet module.

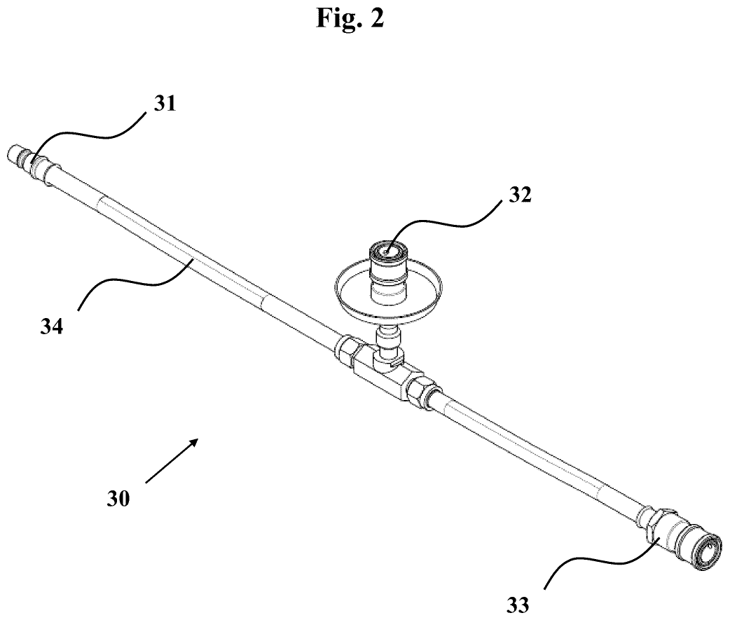

FIG. 2 shows a schematic illustration of an exemplary embodiment of a media distribution device 30 that is designed in T-shape and comprises a first connector 31, a second connector 32 and a third connector 33. The third connector can be arranged in an area of the second side part 12. The three connectors 31, 32, 33 are connected to each other via the line device 34 and are each configured for connection to an adapted connector or a connection device. For example, the first connector 31 is designed as a male connector for insertion, so that the same can be coupled, for example, with a receiving female connector. By coupling a connector to be received with a connector to be inserted, it is possible to obtain a media-tight connection in a particularly advantageous manner.

Further, as illustrated in an exemplary manner, the second and third connectors 32, 33 can each be designed as a receiving female connector, so that these can be connected to a male connector to be inserted, such as the first connector 31, respectively. Here, the second and the third connector 32, 33 are each designed as a spring-loaded quick-action coupling, so that both connector parts can be connected and separated without a tool.

In the illustrated embodiment of the media distribution device 30, the first connector 31 can be connected to a media source, for example. Such a media source can be a gas source, for example, so that the gas can or be distributed flow from the gas source through the first connector 31 towards the second connector 32 and onward to the third connector 33.

The function module 100 designed as a cooking module can, for example, be connected to the media distributing device 30 and be supplied with gas via the second connector 32. For example, a further media distributing device 30 of a further modular frame 1 can be supplied with gas via the third connector 33. The modular frame 1 according to this disclosure can thus be connected to further modular frames in a particularly simple manner. Furthermore, a function module 100 can preferably be changed without a tool and in a particularly simple manner via the media distribution device 30, so that the user can choose, depending on the application, from a number of function modules 100 and use these without having to occupy relatively much space. According to this disclosure, not only gaseous media can be distributed via the media distribution device 30, but rather any media that are to be supplied or discharged during the operation of the function module 100, such as freshwater and gray water, electric energy, and the like, for example.

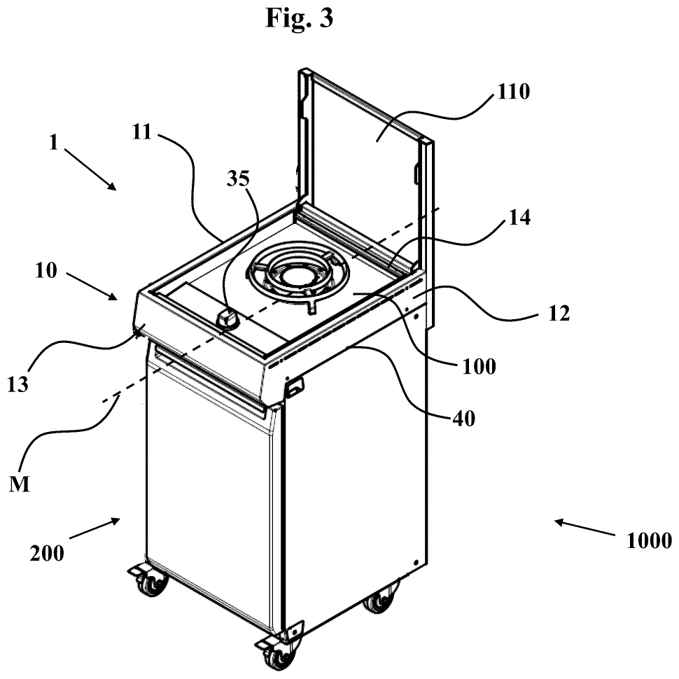

FIG. 3 is a schematic illustration of an exemplary embodiment of a system 1000 for an outdoor kitchen according to the disclosure with a modular frame 1. In the illustrated embodiment, a function module 100 designed as a cooking module is arranged in an upper part of the frame body 10. The system 1000 further comprises a lid 110 to fully cover the function module 100, the lid 110 being pivotally arranged in an area of the rear part 14 of the frame body 1. By providing a hinged lid 110, the function module 100 can be covered in a particularly simple manner, for example to protect it from the weather or to provide an enclosed space below the cover 110 and above the function module 100. In the illustrated exemplary embodiment, the lid 110 can be designed to be linearly displaceable with respect to the frame body 10, in addition to being pivotable, so that, as illustrated, the lid 110, when in an open position, can be displaced downward relative to the frame body 10.

A cabinet module 200 is arranged below the modular frame 1, which cabinet module is connected to the frame body 10 via the second accommodating device 40. The cabinet module 200 can be used, for example, to store a media source, e.g. a gas cylinder, or to store further function modules. In the illustrated embodiment, the cabinet module 200 has side walls and a door arranged in the front area, so that the system 1000 according to the disclosure is of a particularly stable and compact design. Rollers arranged under the cabinet module 200 further make it particularly easy for a user to move the system 1000 according to the disclosure.

In the illustrated embodiment of the system 1000 according to the disclosure, the modular frame 1 has a media control device 35 arranged in the area of the front part 13. For example, the gas flow of a gas supplied by a gas cylinder stored in the cabinet module 200 can be controlled via the media control device 35. The gas is routed to the function module 100 designed as a cooking module via a media distribution device not illustrated. Of course, further elements, such as e.g. a temperature display, can be arranged in the area of the front part 13, besides the media control device 35.

The modular frame 1 of the illustrated system further has a horizontal center axis M, which extends through the frame interior of the frame body 10 and is arranged parallel to the first 11 and second side part 12 and to the front part 13 and the rear part 14, the frame 1 being designed with mirror symmetry starting from the center axis M. The mirror symmetry of the frame 1 is also applied to the cabinet module 200. The cabinet module 200 therefore uses side panels with the same geometry in several positions. The mirror symmetrical design of the frame 1 advantageously reduces the complexity of the modular frame 1 and of the cabinet module 200 arranged on the modular frame 1.

The system 1000 according to this disclosure is thus designed to be particularly compact and space-saving and at the same time offers the user the possibility of using the desired function module 100 in a particularly simple manner according to his needs and of replacing it with another function module 100 if necessary.

List of reference numerals
1 modular frame
10 frame body
11 first side part
12 second side part
13 front part
14 rear part
20 first accommodating device
30 media distributing device
31 first connector
32 second connector
33 third connector
34 line device
35 media control device
40 second accommodating device
100 function module
110 lid
200 cabinet module
1000 system
M center axis

What is claimed is:

1. A modular frame for an outdoor kitchen for the replaceable accommodation of at least one function module, comprising:
a frame body having a first side part and a second side part opposite the first side part, a front part and a rear part opposite the front part for defining a frame interior;
a first accommodating device;
at least one media distribution device,
wherein the at least one media distribution device comprises at least two connectors and a line device,
wherein the line device can distribute at least one medium between the at least two connectors,
a first connector arranged in an area of the first side part; and
a second connector can connect to the at least one function module,
wherein the at least one function module can be connected to the frame body and/or supported at the frame body via the first accommodating device.

2. The modular frame according to claim 1, wherein the line device of the media distribution device is arranged on the front part of the frame body.

3. The modular frame according to claim 1, wherein the first connector and the second connector each can connect to an adapted connector or a connection device.

4. The modular frame according to claim 1, wherein the media distribution device comprises a media control device for controlling at least one media flow in the line device between the first connector and the second connector.

5. The modular frame according to claim 1, wherein the frame body comprises a second accommodating device via which at least one cabinet module can be connected to the frame body.

6. The modular frame according to claim 1, wherein the frame body has a stop on the first side part, the second side part, the front part, and/or the rear part to form a first and/or second accommodation device, via which the corresponding function module and/or cabinet module can be locked on the frame body.

7. The modular frame according to claim 1, wherein the media distribution device is designed in an L-shape, and wherein the first connector is connectable to the function module.

8. The modular frame according to claim 1, wherein the media distribution device has at least one third connector in the area of the second side part.

9. The modular frame according to claim 1, wherein the media distribution device has a fourth connector for the connection of at least one media source.

10. The modular frame according to claim 1, wherein at least one connector is arranged on the frame body via a quick-action device.

11. The modular frame according to claim 8, wherein the media distribution device is T-shaped, wherein the first connector can be connected to the function module via the line device through the second connector, wherein the third connector can be connected to a further media distribution device and/or a further function module via the line device, and wherein the first connector is connected to the third connector and the third connector is connected to the second connector via the line device.

12. The modular frame according to claim 1, wherein the first accommodating device can arrange that the at least one function module at least partly in the area of the frame interior between the front part and the rear part, and between the first side part and the second side part.

13. The modular frame according to claim 1, further comprising a horizontal center axis that extends through the frame interior and arranged parallel to the first side part and second side part and to the front part and the rear part, wherein the frame is designed with mirror symmetry starting from the horizontal center axis.

14. The modular frame according to claim 1, wherein the media distribution device comprises at least one connection device for transmitting data and/or electric energy.

15. The modular frame according to claim 1, wherein the frame body can accommodate an electric energy source for connection to the media distribution device to supply of electric energy to at least one function module accommodated in the frame.

16. A system for an outdoor kitchen comprising:
at least one modular frame; and
at least one function module and/or at least one cabinet module,
wherein the at least one modular frame comprises:
a frame body having a first side part and a second side part opposite the first side part, a front part and a rear part opposite the front part for defining a frame interior;
a first accommodating device;
at least one media distribution device,
wherein the at least one media distribution device comprises at least two connectors and a line device,
wherein the line device is configured to distribute at least one medium between the at least two connectors,
a first connector arranged in an area of the first side part; and
a second connector configured for connection to the at least one function module,
wherein the at least one function module can be connected to the frame body and/or supported at the frame body via the first accommodating device.

17. The system according to claim 16, wherein the function module is designed as a ceramic burner module, a cooking module, a pizza oven, a wok burner, a plancha grill, and/or as an adapter for holding a stainless steel container.

18. The system according to claim 16, wherein the function module has a lid pivotally arranged on the function module to partially or completely cover the function module.

19. The system according to claim 16, wherein at least one further modular frame and/or one further function module is arranged on the modular frame, and wherein the media distribution device of the modular frame can be connected to a media distribution device of the further modular frame.

20. The system according to claim 16, wherein at least one media source and/or one media sink is arranged on the media distribution device.
